(19) United States
(12) Patent Application Publication
(10) Pub. No.: US 2016/0275989 A1
(43) Pub. Date: Sep. 22, 2016

(54) MULTIMEDIA MANAGEMENT SYSTEM FOR GENERATING A VIDEO CLIP FROM A VIDEO FILE

(71) Applicant: OZ ehf, Reykjavik (IS)

(72) Inventor: Gudjon Mar GUDJONSSON, Reykjavik (IS)

(21) Appl. No.: 15/071,635

(22) Filed: Mar. 16, 2016

Related U.S. Application Data
(60) Provisional application No. 62/133,542, filed on Mar. 16, 2015.

(51) Int. Cl. G11B 27/034; G11B 27/10; G11B 27/36; G11B 27/34; H04N 5/76; G11B 27/11

(52) U.S. Cl. CPC G11B 27/034; H04N 5/7605; G11B 27/11; G11B 27/36; G11B 27/34; G11B 27/105

(57) ABSTRACT

A multimedia system for generating a video clip from a video file includes a storage system connected to a network configured to store a collection of video files each associated with a video file identifier uniquely identifying each individual video file. A computer device is connected to the network including a display, and an input unit configured to receive an input command from a user when a selected video file from the collection of video files. The user is uniquely identified by a user identifier, where the input command is processed by the computer device with start and end time parameters of a selected video clip from the selected video file. A processor configured to receive the video ID of the selected video file and the user ID, and utilize as input parameters in extracting the video clip from the selected video file and create a self-contained video clip file.

### FIELD OF THE INVENTION

The present invention relates to a multimedia system and a method for generating a video clip from a video file.

### BACKGROUND OF THE INVENTION

Existing services (e.g. YouTube®, Vimeo®) do not offer a convenient way to generate short clips from existing videos. Users cannot easily share their favorite moment from movie or goal from a football match on social media.

Various external tools exist to ‘rip’ content and create, often illegal, copies, animated gif figures or snippets from videos. These tools do not offer a seamless user experience, are tedious and time demanding and not user friendly.

### SUMMARY OF THE INVENTION

It would be advantageous to achieve a system and a method for generating video clips directly from a video and preferably be able to publish this clip as an individual video moment that can e.g. be shared on social media by the user.

In general, the invention preferably seeks to mitigate, alleviate or eliminate one or more of the above mentioned disadvantages singly or in any combination. In particular, it may be seen as an object of the present invention to provide a multimedia system that solves the above mentioned problems, or other problems, of the prior art.

To better address one or more of these concerns, in a first aspect of the invention a multimedia system is provided for generating a video clip from a video file, comprising:
a storage system communicatively connected to a network configured to store a collection of video files where each of the video files is associated with a video file identifier (ID) uniquely identifying each individual video file,
a computer device communicatively connected to the network comprising:
   a display, and
   an input unit configured to receive an input command from a user when a selected video file from the collection of video files is played to the user via the display, the user being uniquely identified by a user identifier (ID), where the input command is processed by the computer device resulting in a start time parameter and an end time parameter of a selected video clip from the selected video file, the start time parameter indicating a start time of the video clip and the end time parameter indicating an end time of the selected video clip,
a processor configured to receive the video ID of the selected video file and the user ID and utilize as input parameters in extracting the video clip from the selected video file at the storage system and create a self-contained video clip file.

Accordingly, a user friendly system is provided that allows the user to create a video clip from e.g. his/her favorite video in a user friendly way where the selected video clip becomes self-contained video clip file that allows the user to e.g. distribute the video clip globally with e.g. his/her friends vie e.g. social media.

Also, the system may serve as a powerful marketing tool because the users may easily create a video clip from their favorite movie or favorite music video and share it via social media such as Twitter®, Facebook® etc., where the content owner of the video files obviously benefits from such a distribution.

The processor may be a part of an external computer that operates the storage system, or the processor may be comprised in the computer device. In case the processor is comprised in the computer device, the selected video file may first be downloaded on the device.

The term video file may according to the present invention be understood as a pre-recorded video or a video stream that is delivered over the network, where the video file is available to a computer program through an appropriate video file resource.

In one embodiment, the computer device further comprises a confirmation module connected to the processor configured to receive a confirmation command from the user confirming the selection of the video clip, where the processor is configured to create the self-contained video clip file as a response to the confirmation command from the user. The user may thus fully control when the selected video clip is confirmed, where based on the conformation the self-contained video clip file is created.

In one embodiment, the multimedia system further comprises a subscriber module configured to receive information about the user and based thereon creating the user ID, the accessibility to the collection of video files, and the permission to create the video clip being determined based on the user ID. The accessibility to the video files may thus be limited only to those users that are in a subscription to the video files, e.g. upon payment of monthly recurring subscription fee that may be decided by the party managing the video files. The information about the user may as an example include, but is not limited to, at least one of the following: the name of the user, the age of the user, the users address, users email address, information relating to monthly subscription fee, e.g. credit card information etc.

In one embodiment, upon receiving the input command from the user, and prior to creating the self-contained video clip file, a graphical window is presented to the user, and where the video content of the video clip is continuously played within the graphical window. A user friendly way is thus provided that allow the user to see the video clip that may e.g. be a few seconds, e.g. 5-15 second video clip, prior to e.g. confirming that this is the video clip the user had in mind.

In one embodiment, when selecting a video clip the playing of the video file is paused and the video clip is, in addition to running the video clip constantly in a looped way within the graphical window, also played in a looped way and in is synchronized to the video clip within the graphical window. This may be done by temporarily replacing the view of the screen area where the video file was played, where upon confirming the video clip the video file is played again and replaces the playing of the video clip file.

In one embodiment, the graphical window is dimensioned such that it corresponds to the time window of the video clip as defined by the start time and the end time of the video clip, where the graphical window is presented to the user by means of incorporating the graphical window into a timeline of the video file, where the timeline of the video file is used as a time line reference scale for the time window of the video clip. As an example, if the video file played to the user is 125 seconds long, and the user selects 12^{th} second as the start time of the video clip, and assuming the video clip is pre-set to be 10 seconds long, the graphical window is positioned such that the start time, i.e. the 12^{th} second is at the same position as the 12^{th} second of the video clip, and the 22^{nd} of the graphical window is at the same position as the 22^{nd} second of the video clip. Typically, the time lines of both the graphical window and the video file are horizontal lines such that the left side of the graphical window corresponds to the being time (i.e. the 12^{th} second) and the right side corresponds to the end time of the video clip (i.e. the 22^{nd} second).

In one embodiment, the time window of the video clip is adjustable by the user via input command by means of adjusting the dimension of the graphical window within timeline of the video file, the adjustment causing a dynamic update of at least one of the start time and/or the end time of the video clip, wherein the video content of the video clip played within the graphical window is automatically updated in accordance to the new start time and/or end time of the video clip. A user friendly way is thus provided that allows the user, via e.g. dragging finger, to adjust the time of the video clip by dragging e.g. the left side of the window to right or left, and/or do the same to the right window. Referring to the example above, by dragging the left side of the window such that the left side is at 6^{th} second at the time line of the video file, then the start time of the video clip will automatically be changed to 6^{th} second instead of the 12^{th} second. The total time of the video clip would thus be 16 second. The video content of the video clip being played within the graphical window would preferably be updated accordingly, i.e. the clip from 6-22 second would be presented instead of 12-22 second.

In one embodiment, the self-contained video clip file is associated with a video clip file identification (ID) and is stored in the at least one storage system. The video clip may thus e.g. be associated to the user via the clip file ID, and/or the video clip ID may be associated to the owner of the video files, or the video clip file ID may contain information about the user creating the video clip and information about the owner of the video files.

In one embodiment, the multimedia system further comprises a publication module configured to operate the publication of the self-contained video clip file. The publication module may e.g. be managed by the owner of the video files such that all the video clips that are created are automatically publicly available to the public. The publication module may also allow only a pre-defined group of people, e.g. only those that have user ID's, to see and and/or access the self-contained video clip file. This may also be of relevance for honoring Intellectual Property Rights, where e.g. sharing may only be allowed to a limited group of people and not to the public.

In one embodiment, the publication module is operated by the user and is configured to publish the self-contained video clip file in accordance to publication commands from the user. In that way, the user may in a very user friendly way share his most favorable moment by means of sharing the video clip file on e.g. social media such as Facebook®, Twitter® and the like. The time from where the user selected the video clip, from where the self-contained video clip file was created and until the self-contained video clip file has been shared may occur only within few second.

In one embodiment, the multimedia system further comprises a notification module adapted to notify the user when the self-contained video clip file is or has been created. The user may thus be notified via e.g. a short message, color code (e.g. green light when the file has been created) and the like when the self-contained video clip file has been created.

In one embodiment, the received input command from the user triggers a start time parameter of the video clip. Thus, e.g. touching the display may trigger the start time of the video clip. Referring to the previous example, by touching the display when the video file being played is at 12^{th} second, an end time of 22^{nd} second may automatically be triggered.

In one embodiment, the multimedia system further comprises a caption module adapted to receive caption text string from the user where the text string is associated and published with the video clip file. The user may thus “label” the video clip file with e.g. a phrase like “My most favorite video these days”, where this text string is associated to the video clip as e.g. metadata. Thus, when e.g. sharing the video clip the text string appears with the video clip. The caption text string may be received associated to the video clip prior to creating the self-containing video clip file, or after the self-containing video clip file is created.

In one embodiment, the computer device is selected from:
a mobile phone,
a tablet computer,
a portable or stationary computer, or
a digital watch.

In a second aspect of the invention, a method is provided of generating a video clip from a video file, comprising:
providing a user with an access to a storage system communicatively connected to a network configured to store a collection of video files where each of the video files is associated with a video file identifier (ID) uniquely identifying each individual video file, the user being uniquely identified by a user identifier (ID),
selecting a video file of interest selected from the collection of video files,
playing the video file to the user via a display comprised in a computer device, where the computer device is communicatively connected to the network,
receiving an input command from the user via an input unit comprised in the computer device,
processing the input command by the computer device resulting in start time parameter indicating a start time of the video clip and the end time parameter indicating an end time of the selected video clip,
receiving the video ID of the selected video file and the user ID and utilize the received video ID and the user ID as input parameters in extracting the video clip from the selected video file at the storage system and create a self-contained video clip file.

In one embodiment, creating of the self-contained video clip file is performed upon confirmation command from the user.

In one embodiment, the user ID is created via subscription process by the user for allowing the user to access to the collection of video files, and where the accessibility to the collection of video files is limited to users undergoing the subscription process.

In one embodiment, the generation of the video clip from the video file is limited to users having user's ID having undergone the subscription process.

In one embodiment, the publication of the self-contained video clip file is operated by the user.

In one embodiment, the publication of the self-contained video clip file is pre-defined.

In one embodiment, the self-contained video clip file is available to the public.

The method is not only favorable for a user that wants to create his/her favorite moments with e.g. his/her friends, but also the method allows creators of video content, which may e.g. be music videos or video films, to distribute their content globally via plurality of such users preferably upon subscription to the channel, where the video files may be accessed via the Internet on e.g. smart phones and computers.

In one embodiment, the video file is either recorded video or a video stream.

In a third aspect of the invention, a computer readable medium is provided for storing computer readable program code embodied therein for generating a video clip from a video file, the computer readable code comprising instructions which when executed by a processor perform the method of:
providing a user with an access to a storage system communicatively connected to a network configured to store a collection of video files where each of the video files is associated with a video file identifier (ID) uniquely identifying each individual video file, the user being uniquely identified by a user identifier (ID),
selecting a video file of interest selected from the collection of video files,
playing the video file to the user via a display comprised in a computer device, where the computer device is communicatively connected to the network,
receiving an input command from the user via an input unit comprised in the computer device,
processing the input command by the computer device resulting in start time parameter indicating a start time of the video clip and the end time parameter indicating an end time of the selected video clip,
receiving the video ID of the selected video file and the user ID and utilize the received video ID and the user ID as input parameters in extracting the video clip from the selected video file at the storage system and create a self-contained video clip file.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 shows an embodiment of a multimedia system according to the present invention for generating a video clip from a video file,

FIG. 2 depicts graphically a scenario where user via the computer device the shared/published the self-contained video clip file discussed in relation to FIG. 1,

FIGS. 3-7 show graphically a platform allowing the user to create a self-contained video clip file from a video, and

FIG. 8 shows a flowchart of one embodiment of a method according to the present invention.

### DESCRIPTION OF EMBODIMENTS

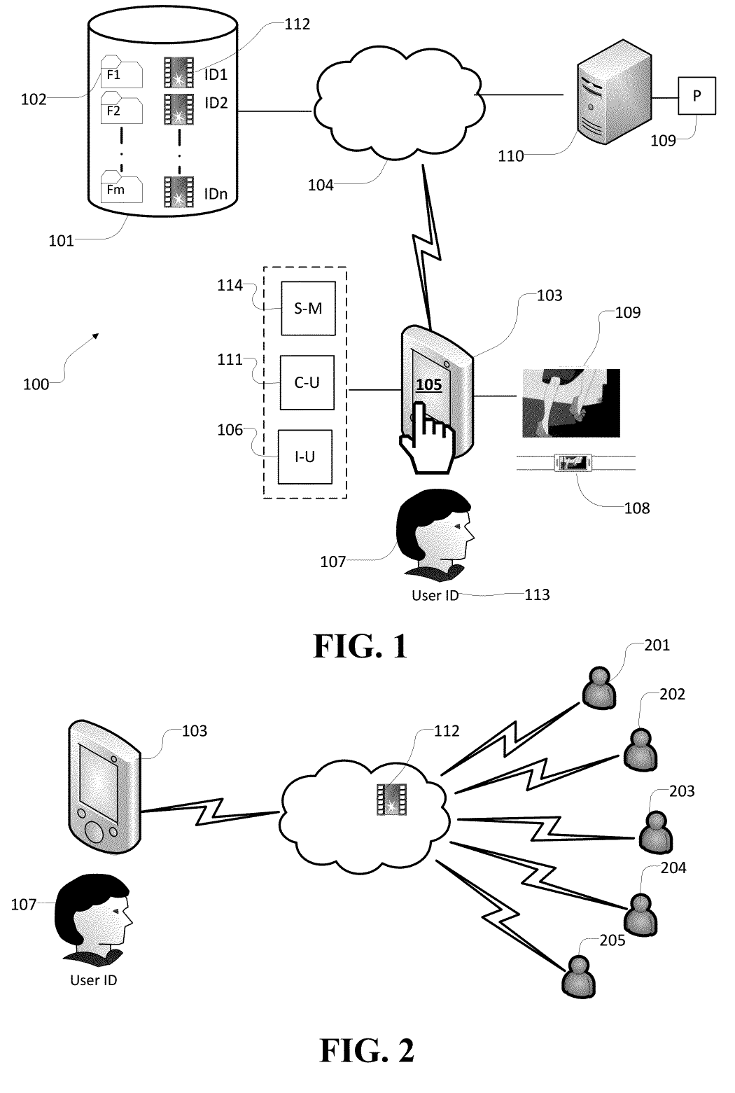

FIG. 1 shows an embodiment of a multimedia system 100 according to the present invention for generating a video clip from a video file.

The multimedia system 100 comprises a storage system 101, a computer device 103 and a processor 109.

The storage system 101 is communicatively connected to a network 104, which may be wired or wireless network, and is configured to store a collection of video files 102 where each of the video files is associated with a video file identifier (ID) that uniquely identifying each individual video file.

The computer device 103 may as an example be a mobile phone, a tablet computer, a portable or stationary computer, and the like, and is communicatively connected to the network 104. The computer device comprises a display 105 and an input unit 106. The input unit 106 is configured to receive an input command from a user 107 when a selected video file 109 from the collection of video files 102 is played to the user via the display 105. The input unit may as an example comprise a keyboard and mouse, or the input unit may comprise touch command module integrated in the computer device, e.g. smart phone or a tablet computer where via touch commands from the user the input command is received.

The user is uniquely identified by a user identifier (ID), where the user ID 113 may as an example be created via subscriber module that is configured to receive information about the user and based thereon creating the user ID. The accessibility to the collection of video files may be based on the user ID. The user ID may also be created via social media where the user has already been associated with a user ID. Further, the requirement for accessing the video files may be based on a recurring subscription fee decided by the owner of the video files.

The input command is subsequently processed by the computer device, i.e. a processor integrated in the computer device, where the processing results in a start time parameter and an end time parameter of a selected video clip from the selected video file, which could e.g. be a music video. The start time parameter indicates a start time of the video clip and the end time parameter indicating an end time of the selected video clip.

The processor 109, which may as shown here be comprised in a central computer system 110 that manages the video files, is configured to receive the video ID of the selected video file and the user ID and utilize as input parameters in extracting the video clip from the selected video file at the storage system and create a self-contained video clip file 109.

It should be noted that processor 110 may also be the processor comprised in the computer device (not shown here), whereby the video file being processed are first downloaded to the computer device, e.g. the mobile phone.

In one embodiment, the computer device further comprises a confirmation module 111 operable connected to the processor 110, where the processor is configured to receive a confirmation command from the user confirming the selection of the video clip. The processor is preferably further configured to create, as a response to the confirmation command from the user, the self-contained video clip file 112 that may subsequently be stored at the storage system 101.

In one embodiment, the multimedia system further comprises a subscriber module 114 configured to receive information about the user and based thereon creating the user ID. The subscriber module may as an example be a platform comprised in the computer device 103 shown here that receives information about the user 107, e.g. full name, age, gender, location, payment information etc. This information may also be received via social media such as Facebook® or Twitter®, where such an user ID has already been created. The accessibility to the video files and in order to be able to create such a video clip may be based on that the user has received such a user ID. Further, the accessibility to the collection of video files may further be based on payment, e.g. monthly payments.

As will be discussed in more details later, prior to creating the self-contained video clip file, a graphical window 108 is presented to the user, and where the video content of the video clip is continuously played within the graphical window so as to visually show the user the selected video clip, before the video clip file is created. The graphical window is in one embodiment dimensioned such that it corresponds to the time window of the video clip as defined by the start time and the end time of the video clip and is presented to the user by means of incorporating the graphical window into a timeline of the video file, where the timeline of the video file is used as a time line reference scale for the time window of the video clip.

The user can then e.g. via drag command move the graphical window back and forth, which automatically triggers changes in the start time and end time of the video clip, and where preferably the video clip being played within the graphical window is updated accordingly. Further, and as will be discussed in more details later, the user may be able to adjust the start time and end time by increasing or decreasing the dimension of the graphical window.

FIG. 2 depicts graphically a scenario where the user 107, vie the computer device 103, has shared/published the self-contained video clip file 112 discussed in relation to FIG. 1 via e.g. social media, e.g. Facebook® where e.g. a limited group of users 201-205 have an access to the self-contained video clip file 112. The self-contained video clip file 112 may also be accessed by the public.

The publishing of the self-contained video clip file may be managed the owner of the video files where only a limited group of people has access to the self-contained video clip file, e.g. those that have similar user ID's. The owner of the video files may also use the system according to the present invention as a marketing tool where the self-contained video clip file 112 is utilized and shared worldwide. This could e.g. be a part of a new film, where the self-contained video clip file 112 contains 20 seconds from the film.

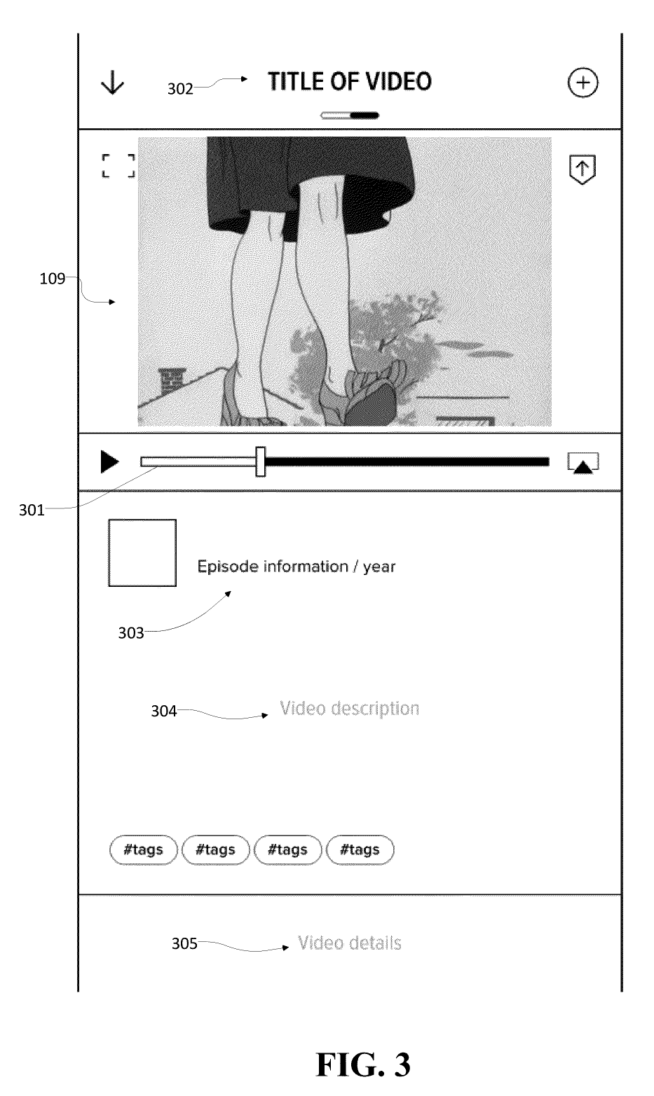

FIGS. 3-8 show graphically an interface/platform allowing the user to create a self-contained video clip file from a video.

In FIG. 3, it is assumed that a user has entered a collection of video files and downloaded a selective video file 109 from the collection of video files to the computer device 103 (see FIG. 1), e.g. a mobile phone.

The content owner of the video files may require a user ID via a subscription process as discussed in relation to FIG. 1, and may also require monthly payments for accessing the video files.

In the user interface shown here, which should of course not be construed to be limited to this particular user interface, shows a time line 301 of the video being played, the title of the selected video file 302, the episode information/year 303, video description 304 and video details 305, but this information may as an example be metadata that is associated with the video file.

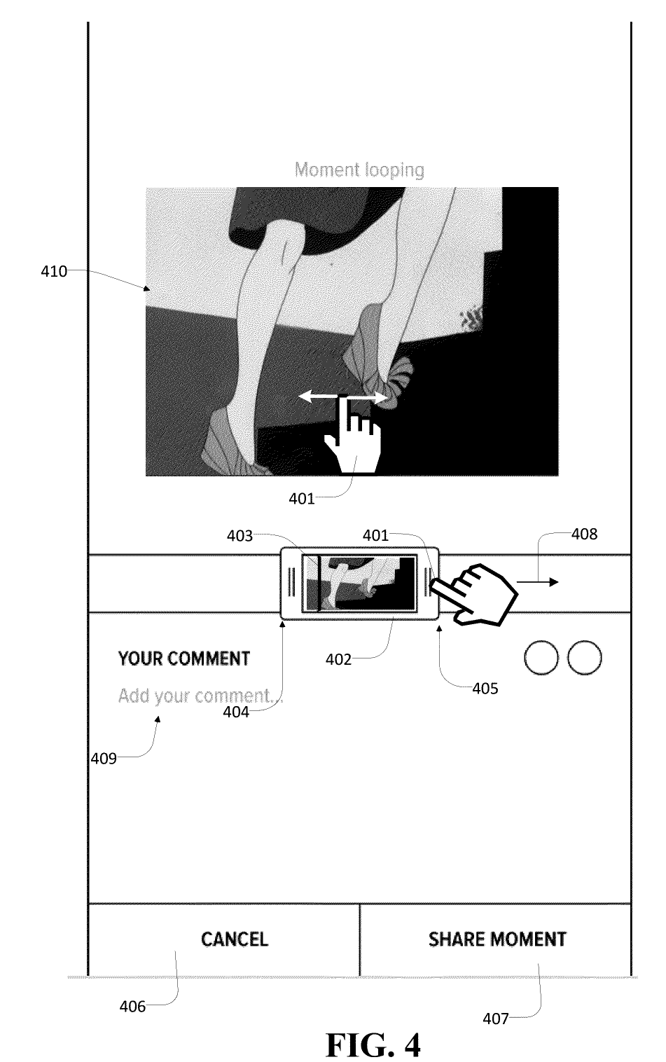

FIG. 4 shows where the user selects a video clip via touch command 401 whereby the start time and end time parameters are automatically triggered indicating the start and end time of the video clip. It should be noted at this time point the self-contained video clip file has not yet been created.

The touch commands from the user further triggers an appearance of the graphical window 402 as discussed in relation to FIG. 1, where the video content of the video clip is continuously played within the graphical window in a loop. The vertical line 403 indicates the time of the video clip within the graphical window 402.

In one embodiment, the width of the graphical window is dimensioned such that it corresponds to the time window or time line 301 of the video clip as defined by the start time 404 and the end time 405 of the video clip. As shown here, the graphical window is presented to the user by means of incorporating the graphical window into a timeline of the video file, where the timeline of the video file is used as a time line reference scale for the time window of the video clip. As shown here, the time points 404 and 405 are the same as the times of the video file at these same positions.

In one embodiment, when selecting a video clip the video file is paused (not shown here) and the video clip is, in addition to running the video clip constantly in a looped way within the graphical window, played in a larger view 410 as shown here in a synchronized manner with the video clip within the graphical window, where it may temporarily replace the video file while the user is selecting the video clip.

In one embodiment, by moving the finger 401 left or right as indicated by the white arrows, the graphical window will be moved automatically and thus the position of the graphical window 402 will be moved accordingly. Moreover, the content of the video clip will automatically be adjusted accordingly due to the new start time and new end time.

In one embodiment, via touch command the dimension of the graphical window may be adjusted by e.g. touching the right side of the window as shown here and e.g. move the finger back and forth. As shown here, by moving the finger in the direction as indicated by arrow 408 the end time is adjusted such that the time of the video clip is increased. The same applies when adjusting the start time, i.e. the left side of the graphical window, where the time of the video clip will be adjusted accordingly. Also, similarly both the start time and the end time may be adjusted simultaneously by touching both sides of the graphical window with two fingers.

The interface shown here further includes a “cancel” touch button 406 and a publication module or as shown here, a “share moment” touch button 407. The cancel touch button is for canceling a selected moment, and the share touch button is when the moment, after creating the self-contained video clip file, the user wishes to share the moment vie e.g. social media.

Further, the interface in this embodiment further comprises a caption module 409 adapted to receive caption text string from the user, prior to creating the self-contained video clip file, where subsequent to creating the self-contained video clip file text string is associated and published with the video clip file.

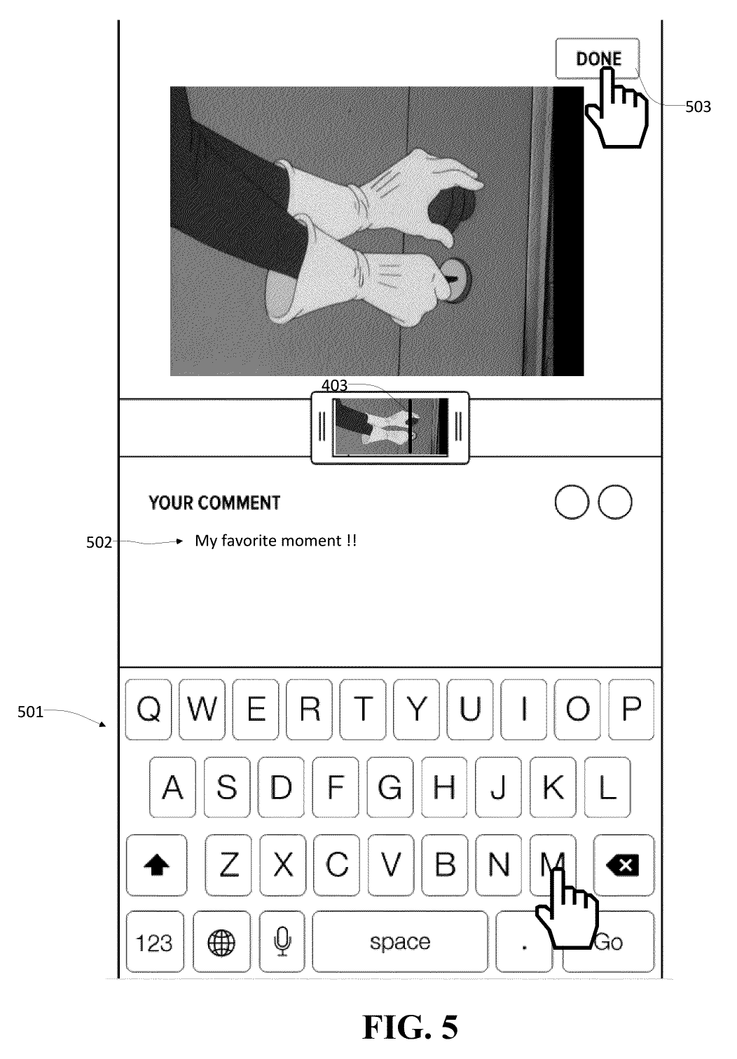

FIG. 5 shows the video clip from FIG. 4 at some later time point, e.g. several seconds later, as indicated by the vertical line 403. As shown here, the user has in the caption module, which as shown here is a touch keyboard 501, entered the text “My favorite moment!!”. This text string is subsequently associated with the video clip, e.g. as metadata.

When the user is satisfied with the video clip he/she confirms this via a confirmation module, which as shown here is the “Done” touch button 503. When confirming the video clip the self-contained video clip file is created.

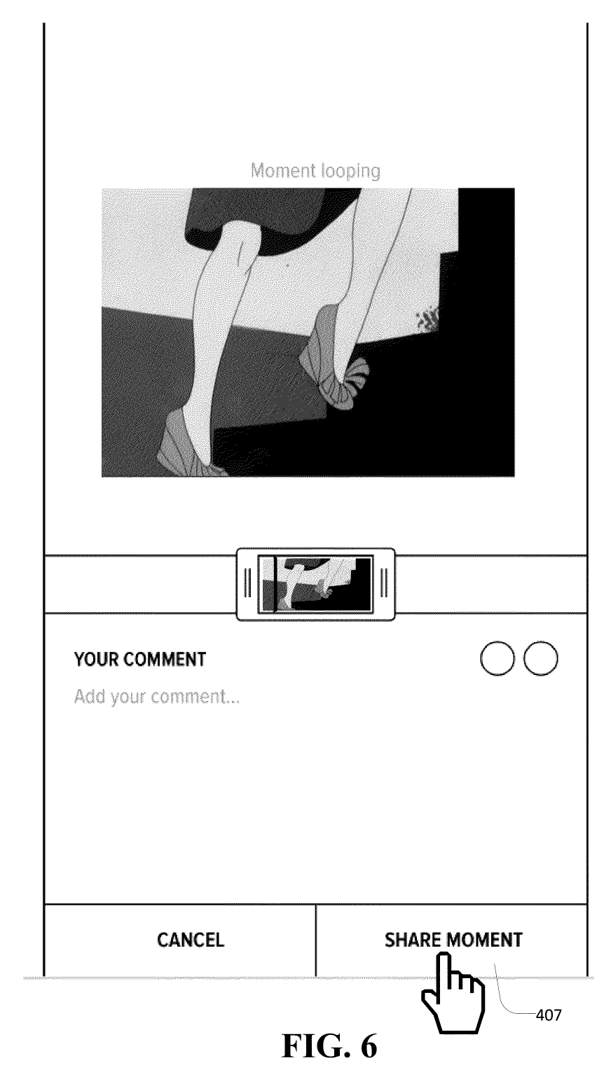

FIG. 6 shows where the video clip has been confirmed (see FIG. 5) and where the user shares the video clip via the “Share moment” button.

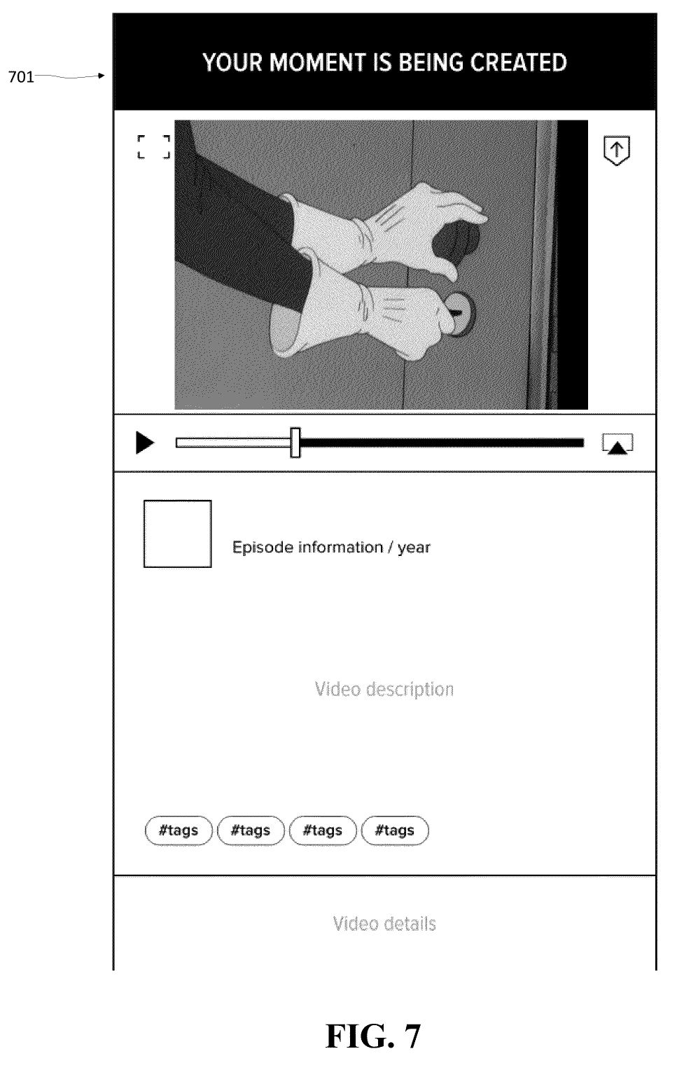

FIG. 7 shows a notification module, which is adapted to notify the user when the self-contained video clip file is or has been created. As shown here, the notification module is a text frame 701 where the user is notified via a text message.

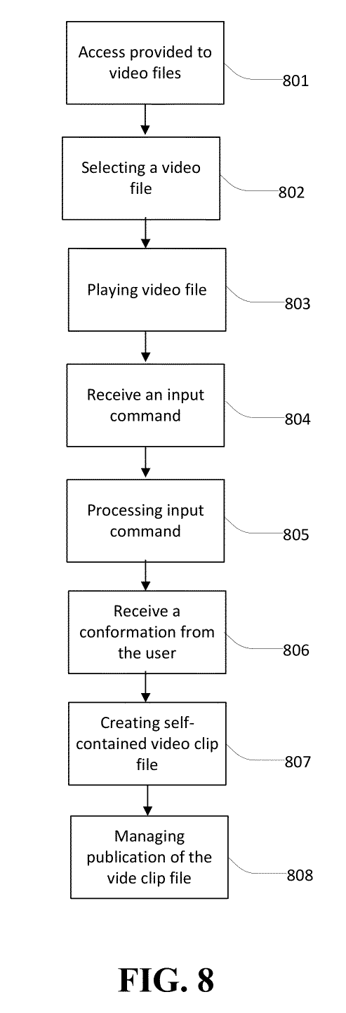

FIG. 8 shows a flowchart of one embodiment of a method according to the present invention for generating a video clip from a video file.

In a first step 801 a user is provided with an access to a storage system that is communicatively connected to a network configured to store a collection of video files where each of the video files is associated with a video file identifier (ID) uniquely identifying each individual video file, and where the user is uniquely identified by the user identifier (ID). The user ID may be created via subscription process by the user for allowing the user to access to the collection of video files, and where the accessibility to the collection of video files may be limited to users undergoing the subscription process. The user may even pay a subscription fee for accessing the video files, which may be movies, music videos etc.

In a second step 802 the user selects a video file of interest selected from the collection of video files. This may e.g. be performed by means of the user logging to an Internet site hosting the collection of video files.

In a third step 803, the selected video file is played to the user via a display comprised in a computer device, where the computer device is communicatively connected to the network. The device may e.g. home computer, portable computer device such as mobile phone, tablets etc.

In a fourth step 804 an input command from the user is received via an input unit comprised in the computer device. This may include, as previously discussed, a touch command where upon touching a touch screen the command is triggered, e.g. the starting time of the video clip, where at the time of touching the touch screen the start time is defined corresponding to the time of the video being played. If e.g. the time of the video being played is 23 seconds, the start time of the video clip will be this exact moment. The initial time of the video clip is preferably pre-defined, e.g. 15 seconds, meaning that the end time of the video clip will be at 23+15=38 second at the video. As already discussed in relation to FIGS. 1-8, this time window of the video clip may preferably be adjusted by the user.

In a fifth step 805, the input command is processed by the computer device resulting in start time parameter indicating a start time of the video clip and the end time parameter indicating an end time of the selected video clip.

In a sixth step 806, the selected video clip is confirmed by the user, i.e. when the user is satisfied with the video clip. This may be done via a confirmation module as discussed previously.

In a seventh step 807, the video ID of the selected video file and the user ID is received and utilized as input parameters in extracting the video clip from the selected video file at the storage system and create a self-contained video clip file. The self-contained video clip file may be associated with a file identification that may include information about who created the file, the owner of the video file collection etc.

In an eight step 808, the self-contained video clip file is published via a publication module but this may be operated by the user via social media where e.g. the user may “share” the self-contained video clip file on Facebook®, Twitter® etc. The self-contained video clip file may also be available to the public.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. A multimedia system for generating a video clip from a video file, comprising:
a storage system communicatively connected to a network configured to store a collection of video files where each of the video files is associated with a video file identifier (ID) uniquely identifying each individual video file,
a computer device communicatively connected to the network comprising:
a display, and
an input unit configured to receive an input command from a user when a selected video file from the collection of video files is played to the user via the display, the user being uniquely identified by a user identifier (ID), where the input command is processed by the computer device resulting in a start time parameter and an end time parameter of a selected video clip from the selected video file, the start time parameter indicating a start time of the video clip and the end time parameter indicating an end time of the selected video clip,
a processor configured to receive the video ID of the selected video file and the user ID and utilize as input parameters in extracting the video clip from the selected video file at the storage system and create a self-contained video clip file.

2. The multimedia system according to claim 1, wherein the computer device further comprises a confirmation module connected to the processor configured to receive a confirmation command from the user confirming the selection of the video clip, where the processor is configured to create the self-contained video clip file as a response to the confirmation command from the user.

3. The multimedia system according to claim 1, further comprising a subscriber module configured to receive information about the user and based thereon creating the user ID, the accessibility to the collection of video files, and the permission to create the video clip, being determined based on the user ID.

4. The multimedia system according to claim 1, wherein upon receiving the input command from the user, and prior to creating the self-contained video clip file, a graphical window is presented to the user, and where the video content of the video clip is continuously played within the graphical window.

5. The multimedia system according to claim 1, wherein the computer device is configured to, while continuously playing the video clip within the graphical window, pause the video file presented to the user.

6. The multimedia system according to claim 4, wherein the graphical window is dimensioned such that it corresponds to the time window of the video clip as defined by the start time and the end time of the video clip, where the graphical window is presented to the user by means of incorporating the graphical window into a timeline of the video file, where the timeline of the video file is used as a time line reference scale for the time window of the video clip.

7. The multimedia system according to claim 6, wherein the time window of the video clip is adjustable by the user via input command by means of adjusting the dimension of the graphical window within timeline of the video file, the adjustment causing a dynamic update of at least one of the start time and/or the end time of the video clip, wherein the video content of the video clip played within the graphical window is automatically updated in accordance to the new start time and/or end time of the video clip.

8. The multimedia system according to claim 1, wherein the self-contained video clip file is associated with a video clip file identification (ID) and is stored in the at least one storage system.

9. The multimedia system according to claim 1, further comprising a publication module configured to operate the publication of the self-contained video clip file.

10. The multimedia system according to claim 9, wherein the publication module is operated by the user and is configured to publish the self-contained video clip file in accordance to publication commands from the user.

11. The multimedia system according to claim 1, further comprising a notification module adapted to notify the user when the self-contained video clip file is or has been created.

12. The multimedia system according to claim 1, wherein the received input command from the user triggers a start time parameter of the video clip.

13. The multimedia system according to claim 1, further comprising a caption module adapted to receive caption text string from the user where text string is associated and published with the video clip file.

14. The multimedia system according to claim 1, wherein the computer device is selected from:
a mobile phone,
a tablet computer,
a portable or stationary computer, or
a digital watch.

15. A method of generating a video clip from a video file, comprising:
providing a user with an access to a storage system communicatively connected to a network configured to store a collection of video files where each of the video files is associated with a video file identifier (ID) uniquely identifying each individual video file, the user being uniquely identified by a user identifier (ID),
selecting a video file of interest selected from the collection of video files,
playing the video file to the user via a display comprised in a computer device, where the computer device is communicatively connected to the network,
receiving an input command from the user via an input unit comprised in the computer device,
processing the input command by the computer device resulting in start time parameter indicating a start time of the video clip and the end time parameter indicating an end time of the selected video clip,
receiving the video ID of the selected video file and the user ID and utilize the received video ID and the user ID as input parameters in extracting the video clip from the selected video file at the storage system and create a self-contained video clip file.

16. The method according to claim 15, wherein the creating of the self-contained video clip file is performed upon confirmation command from the user.

17. The method according to claim 15, wherein the user ID is created via subscription process by the user for allowing the user to access to the collection of video files, and where the accessibility to the collection of video files is limited to users undergoing the subscription process.

18. The method according to claim 17, wherein the generation of the video clip from the video file is limited to users having user's ID having undergone the subscription process.

19. The method according to any of the claim 15, wherein the publication of the self-contained video clip file is operated by the user.

20. A computer readable medium storing computer readable program code embodied therein for generating a video clip from a video file, the computer readable code comprising instructions which when executed by a processor perform the method of:
providing a user with an access to a storage system communicatively connected to a network configured to store a collection of video files where each of the video files is associated with a video file identifier (ID) uniquely identifying each individual video file, the user being uniquely identified by a user identifier (ID),
selecting a video file of interest selected from the collection of video files,
playing the video file to the user via a display comprised in a computer device, where the computer device is communicatively connected to the network,
receiving an input command from the user via an input unit comprised in the computer device,
processing the input command by the computer device resulting in start time parameter indicating a start time of the video clip and the end time parameter indicating an end time of the selected video clip,
receiving the video ID of the selected video file and the user ID and utilize the received video ID and the user ID as input parameters in extracting the video clip from the selected video file at the storage system and create a self-contained video clip file.
